(19) United States
(12) Patent Application Publication
(10) Pub. No.: US 2014/0310205 A1
(43) Pub. Date: Oct. 16, 2014

(54) CONSTRAINT-BASED CONFIGURATION SUPPORTING CALCULATIONS

(71) Applicant: MICROSOFT CORPORATION, Redmond, WA (US)

(72) Inventors: Lasse Nisted, Solrod Strand (DK); Dennis Conrad, Frederiksberg (DK)

(73) Assignee: Microsoft Corporation, Redmond, WA (US)

(21) Appl. No.: 13/862,485

(22) Filed: Apr. 15, 2013

(51) Int. Cl. G06N 5/02

(52) U.S. Cl. CPC G06N 5/02
USPC 706/11

(57) ABSTRACT

A constraint-based configurator receives a configuration property expressed as a numeric value. A calculation is performed using the numeric value and a constraint is evaluated based on the result of the calculation. An output is automatically displayed based on the evaluated constraint.

### BACKGROUND

There are currently many different uses for configurators, or configuration systems. For instance, a product configuration system allows a user to configure a product that the user is purchasing. As one specific example, if a user is purchasing a computer, the user can go on-line and use a product configurator to configure the computer, just the way the user desires, so that the user's personally configured computer is shipped.

In general, there are two types of configuration systems that can be used. The first is a rule-based configuration system. In such a system, a set of rules are employed to implement configuration. Based on user inputs, part of a rule is matched and the rule executes. However, rule-based configuration systems have been found disadvantageous in a number of areas. For example, rule-based systems attempt to have a rule that covers every specific user input. It can be very difficult to author a comprehensive set of rules, and such a system is fairly brittle. If a rule is not matched, the rule-based system can encounter problems. Thus a large set of rules is normally needed.

An example might be helpful in illustrating differences between rule-based configuration systems and constraint-based systems. In most cases, rules will be expressed in an If-Then-Else form. For example, assume one wants to ensure that two color variables have the same color. In a rule-based configuration system this would be modeled, in general, as follows:
If (ColorDoor !=Blank)
Then
ColorFrame=ColorDoor
If (ColorFrame !=Blank)
Then
ColorDoor=ColorFrame
Due to the declarative nature of constraint programming, the same can be achieved with one constraint
ColorDoor=ColorFrame
   Therefore, there has been a move away from rule-based configuration systems toward constraint-based configuration systems.

Constraint-based configuration systems employ a constraint satisfaction problem solver or another type of constraint solver that implements combinatorial constraints in the configurator. Using the above example of a computer configuration system, if a user is attempting to configure a computer, it may be that the computer manufacturer does not offer a computer that has both an optical drive and an extra hard drive. In that case, the configurator or configuration system, implements a constraint that does not allow the user to select both options. In another example, if the user is attempting to order a certain model of television, that model may only be made in certain sizes. Therefore, a constraint is implemented which only allows the user to choose a television, of the given model, in one of the available sizes. However, many constraint-based configuration systems do not support properties that are expressed using decimal values. Similarly, many constraint-based configuration systems do not perform numerical calculations, with decimals or floating point expressions.

Some constraint-based configuration systems do perform numerical calculations. However, in order to do so, they require a separate user input. For instance, if the constraint-based configuration system is performing a calculation that comprises a value A multiplied by a value B, the user is required to put in both values A and B and then actuate a separate user input mechanism in order to have the result of the calculation displayed.

The discussion above is merely provided for general background information and is not intended to be used as an aid in determining the scope of the claimed subject matter.

### SUMMARY

A constraint-based configurator receives a configuration property expressed as a numeric value. A calculation is performed using the numeric value and a constraint is evaluated based on the result of the calculation. An output is automatically displayed based on the evaluated constraint.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one embodiment of a constraint-based configuration system.

FIG. 2 is a flow diagram illustrating one embodiment of the overall operation of the system shown in FIG. 1.

FIGS. 3A-3J are exemplary user interface displays.

FIGS. 4-6 show different implementations of a constraint-based configuration system.

FIG. 7 is a block diagram of various architectures in which the constraint-based configuration system can be deployed.

FIGS. 8-12 show a plurality of different mobile devices.

FIG. 13 is a block diagram of one illustrative computing environment.

### DETAILED DESCRIPTION

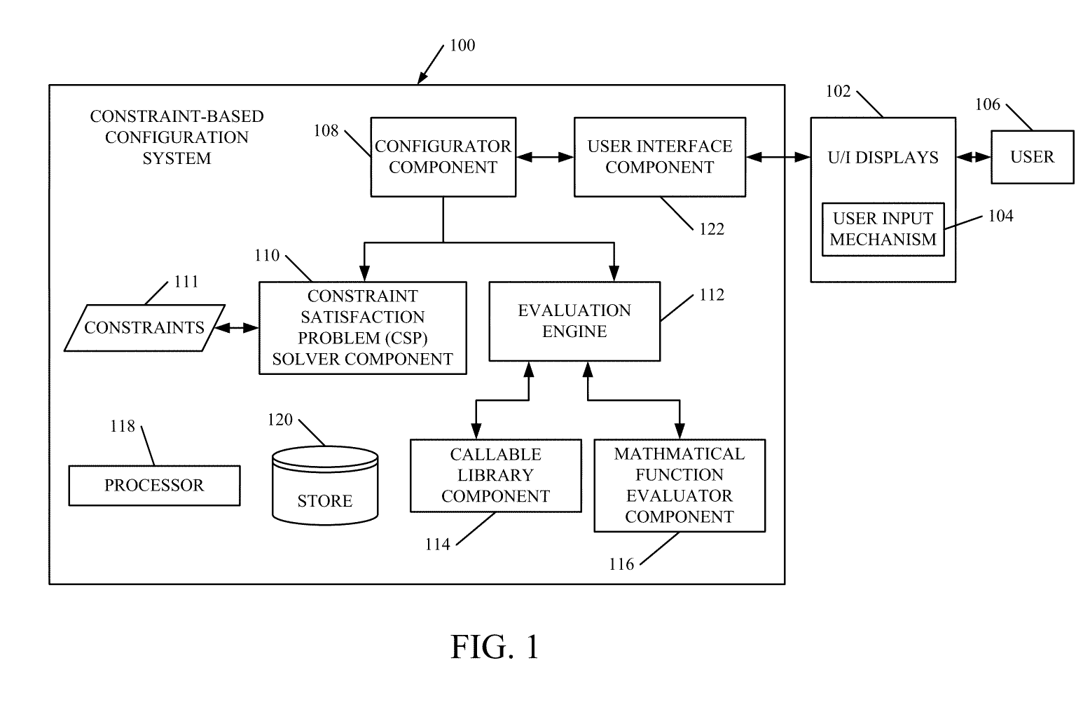

FIG. 1 is a block diagram of one illustrative constraint-based configuration system 100. System 100 is shown generating user interface displays 102 with user input mechanism 104 for use by user 106. In the embodiment shown in FIG. 1, system 100 includes configurator component 108, constraint satisfaction problem (CSP) solver component 110, and evaluation engine 112. CSP solver component 110 is shown accessing a set of constraints 111. Evaluation engine 112 is illustratively coupled to callable library component 114 and mathematical function evaluator component 116. System 100 also illustratively includes processor 118 and data store 120. FIG. 1 also shows that, in one embodiment, system 100 includes user interface component 122.

Configurator component 108 generates user interface displays 102, using user interface component 122. User interface displays 102 have user input mechanisms 104 that allow user 106 to configure an item to be configured. In the embodiment discussed with respect to FIG. 1, constraint-based configuration system 100 will be deployed as a product configuration system which allows user 106 to configure products. Of course, this environment is described for the sake of example only and a wide variety of other environments could be used as well. Some of those are described below.

Processor 118 is illustratively a computer processor with associated memory and timing circuitry (not separately shown). It is illustratively a functional part of system 100 and is activated by, and facilitates the functionality of, the various components and engines in system 100.

Data store 120 illustratively stores data and other instructions that can be used by processor 118 in facilitating the functionality of the components and engines in system 100. Of course, data store 120 can store other data as well. It should also be noted that while store 120 is shown as a single data store that is part of system 100, it can be multiple different data stores as well. In addition, the data stores can be local to system 100 or remote from system 100 (and accessible by system 100), or some can be local and some can be remote.

It will also be noted that various components and engines have been shown in system 100. However, those components and engines can be combined into fewer components or engines that perform the functionality, or they can be divided into more components and engines, each of which performs a subset of the functionality. All of these architectures are contemplated herein.

Before describing the operation of system 100 in detail, an overview will be given for enhanced understanding. User 106 provides user inputs using user input mechanisms 104 on displays 102 to configure a product. User input mechanisms 104 can include any of a wide variety of user input mechanisms, such as buttons, links, dropdown menus, check boxes, grids, or other user actuatable input mechanisms. They can be actuated in a wide variety of different ways as well. For instance, where user interface displays 102 are displayed on a touch sensitive display screen, user 106 can actuate user input mechanisms 104 using his or her finger, a stylus, or another device. Similarly, the user input mechanisms 104 can be a soft keyboard displayed on the display device, a hardware keyboard, a point and click device, such as a mouse or trackball, and where constraint-based configuration system 100 is provided with speech recognition components, the user 106 can activate user input mechanisms 104 using voice commands. Also, user input mechanisms 104 can be actuated using a thumb pad, a keypad, or a wide variety of other items as well.

When user 106 has provided user inputs, configurator 108 uses constraint satisfaction problem (CSP) solver component 110 to solve the combinatorial constraints used to configure a product. While the present discussion proceeds describing the system with a CSP solver, any constraint solver can be used. For instance, a satisfiability solver (SAT solver) can be used or another constraint solver. CSP solver is described for the sake of example only. By way of example, if a user is ordering a television set from a seller, it may be that a certain size of television only comes from the seller in silver and black, but not white. Therefore, CSP solver component 110 receives the user inputs and applies and solves the constraints 111. It will be noted of course, that constraints 111 can be stored in store 120 or they can be stored separately or they can be external to system 100 and accessed by system 100, etc.

Configurator component 108 uses evaluation engine 112 to evaluate mathematical formulas or to call methods for evaluation. A mathematical or logical formula is a mathematical or logical function that takes as an input one or more variables and targets as an output one or more variables. The variables can be numeric or other types. The methods can be internal to the system or external. For example, they can be in a callable library, at a third party system, etc. Evaluation engine 112 illustratively accesses mathematical function evaluator component 116 to evaluate mathematical functions based on inputs provided by user 106. Mathematical function evaluator component 116 has a set of formulas with given sets of input variables and a target variable. When the user or another component provides the input variables, component 116 evaluates the formulas to obtain a target value as a result.

Evaluation engine 112 can also call callable library component 114 in order to perform evaluations. Callable library component 114 includes a collection of methods with given sets of input variables and a target variable or multiple target variables. The present discussion proceeds with respect to the embodiment having a single target variable for the sake of example only. When the user 106 provides one or more of the input variables, evaluation engine 112 can call callable library component 114 to obtain the target variable, or an estimate of the target variable. For instance, evaluation engine 112 can still evaluate and invoke functions and methods where some input variables are not set or inferred. This can be done, for instance, where those with missing values can use a default value for each variable type. Evaluation engine 112 provides the evaluated variables to configurator component 108 which can notify CSP solver component 110 that new values have been obtained so that CSP solver component 110 can solve various constraints 111, based on the new values.

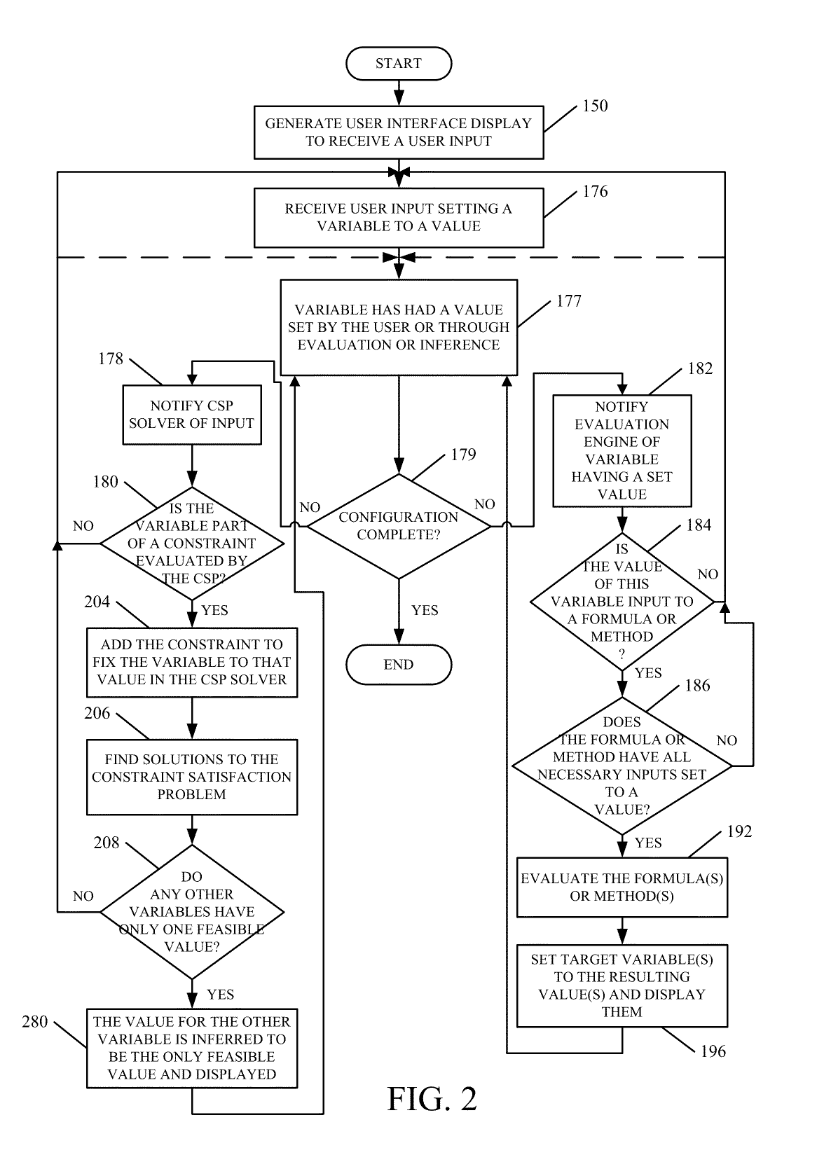

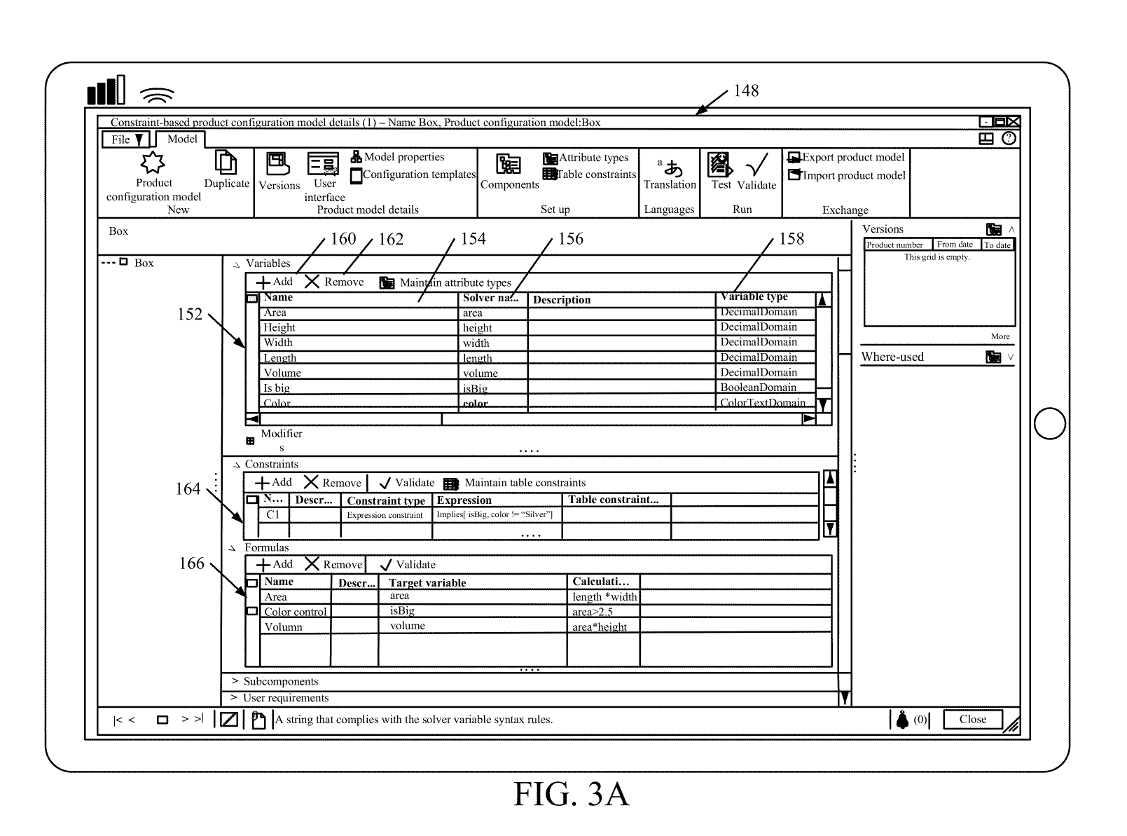

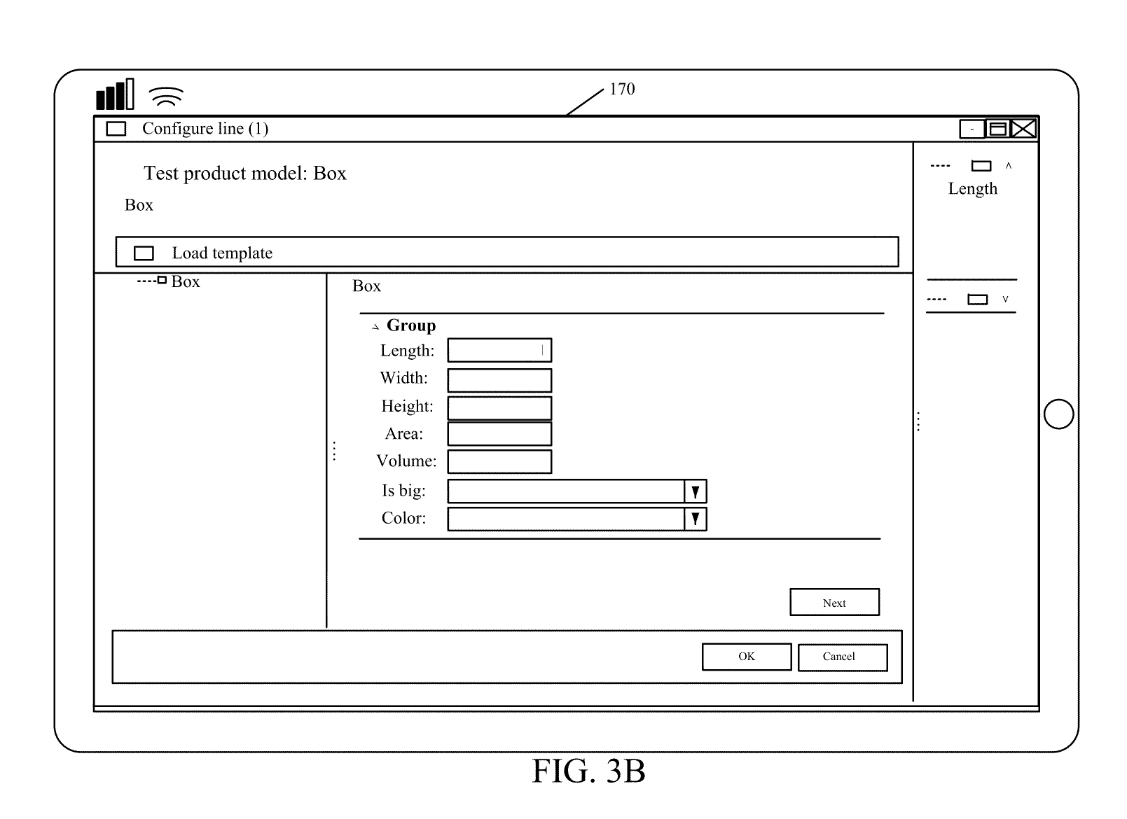

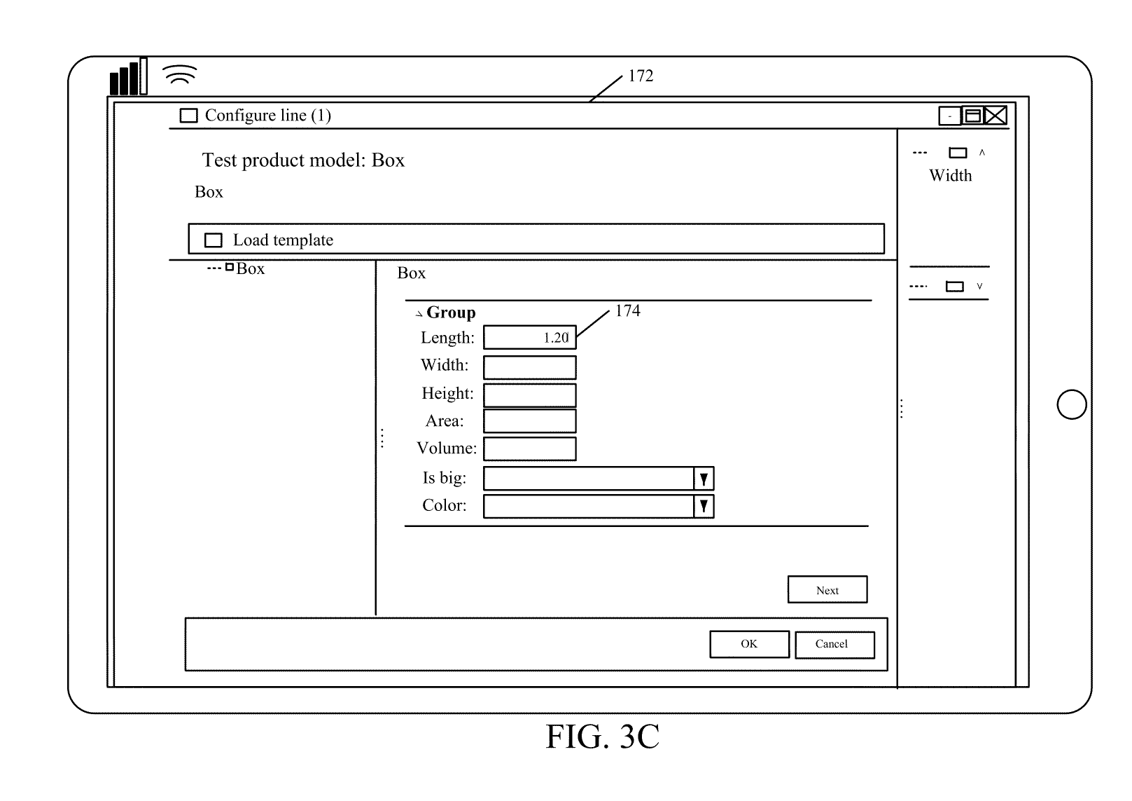

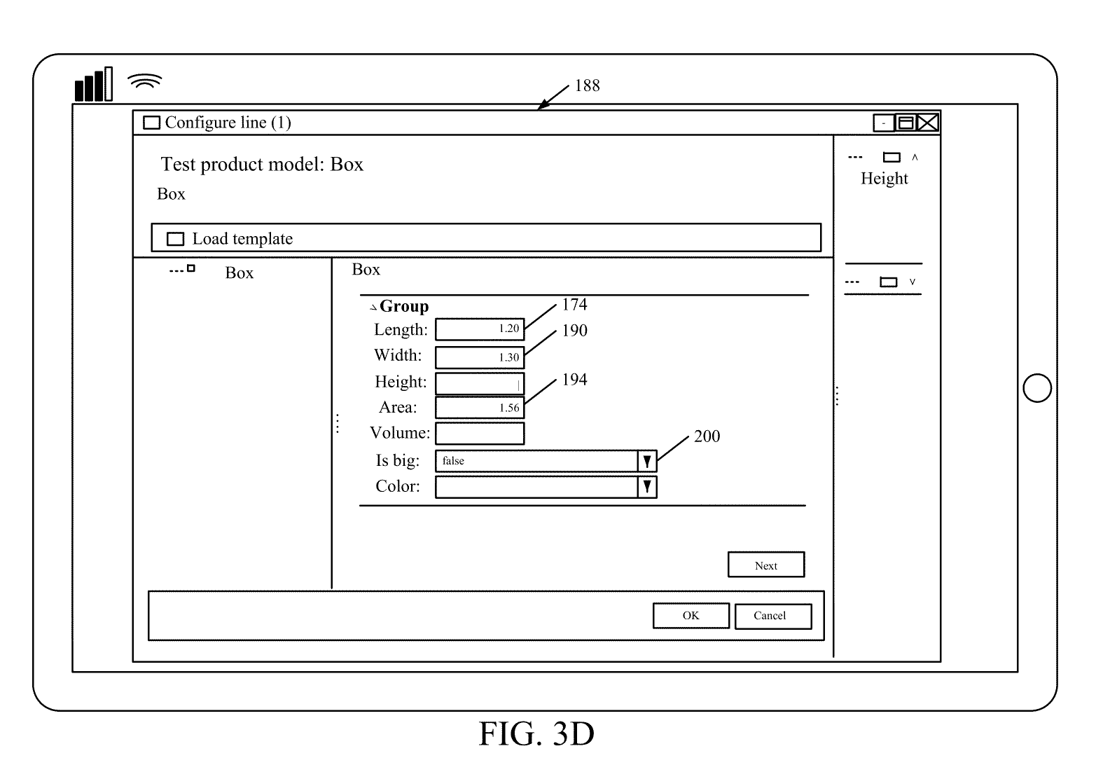

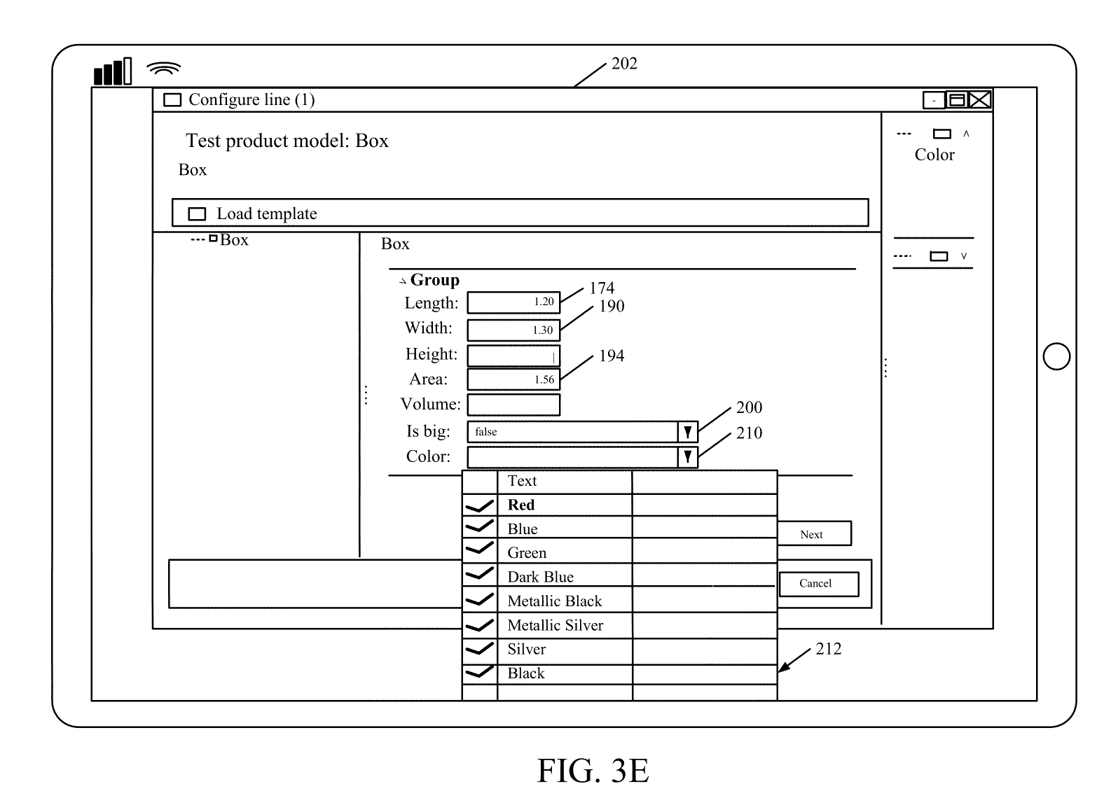

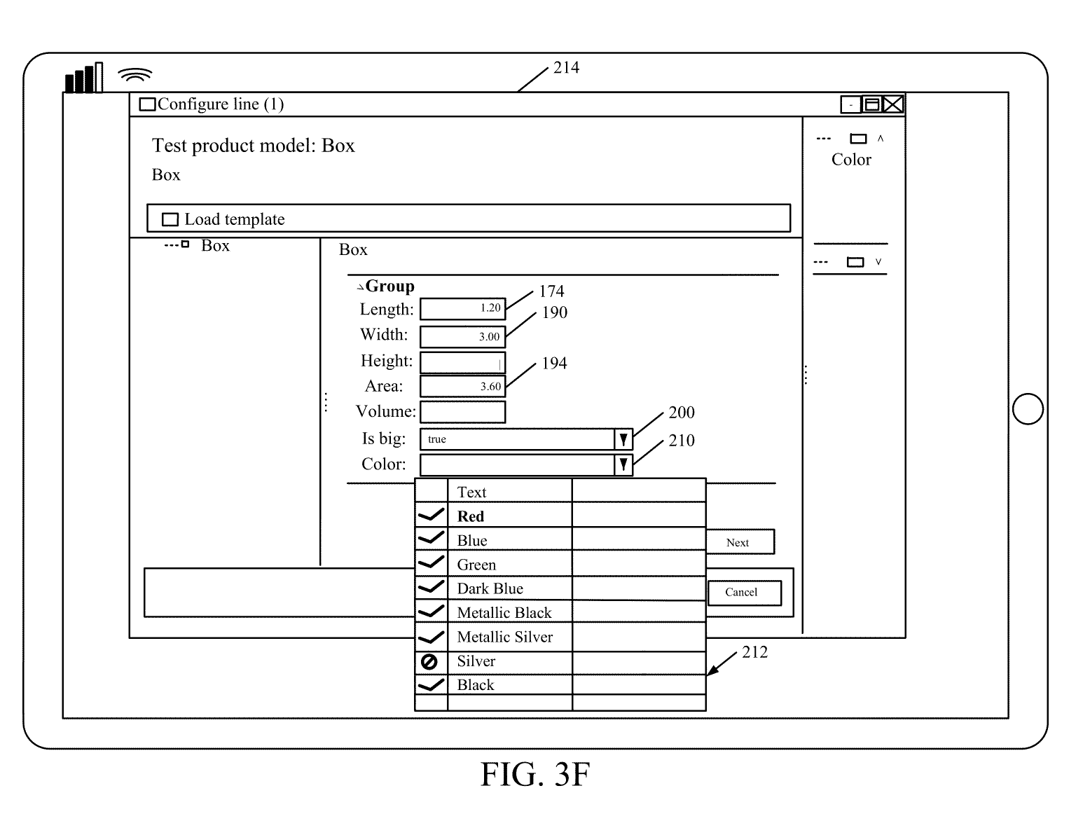

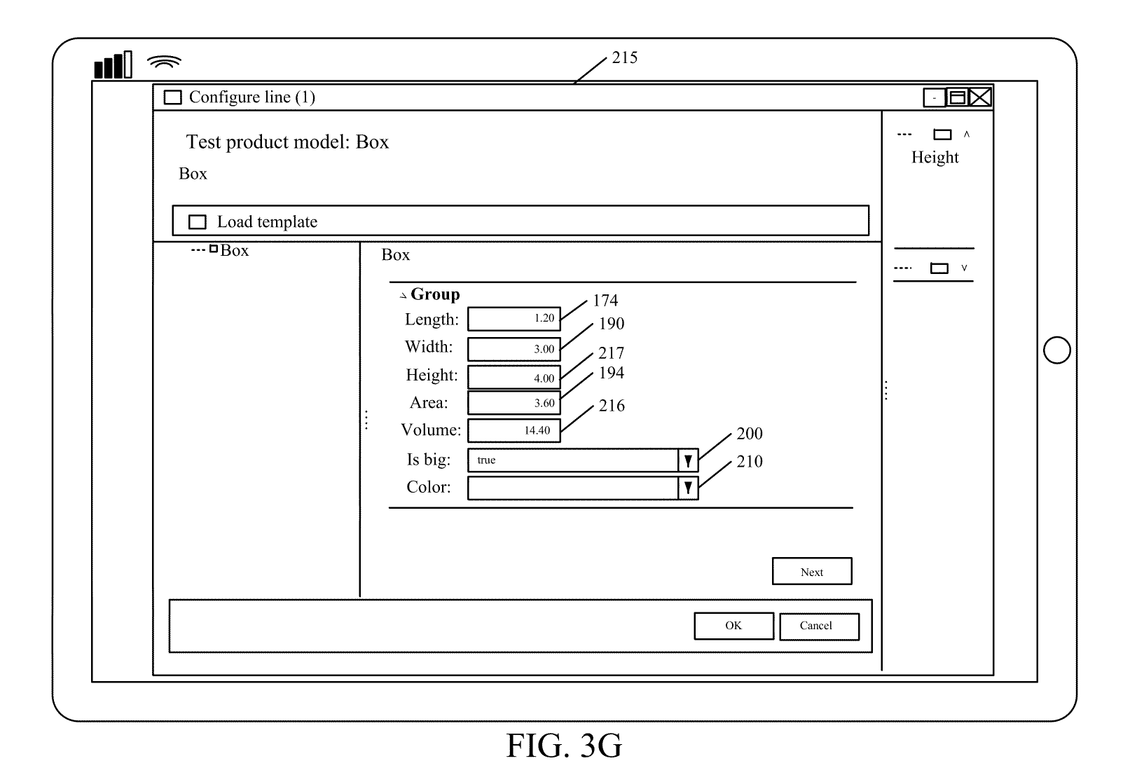

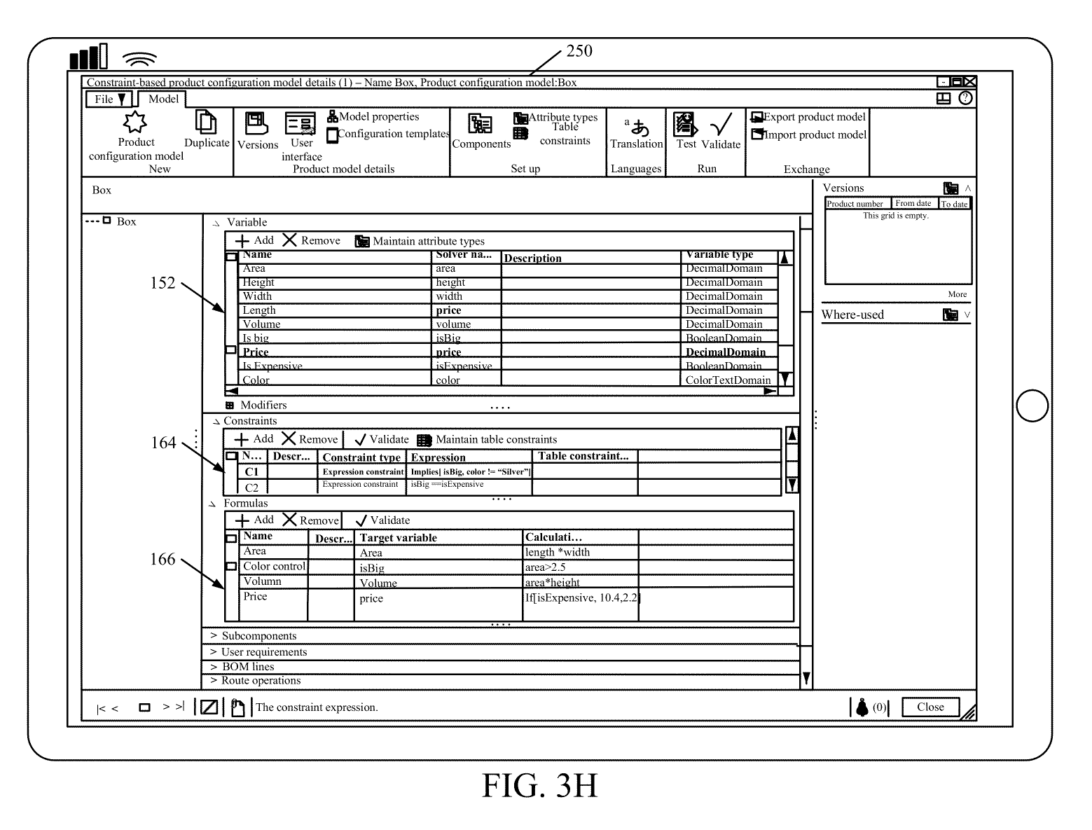

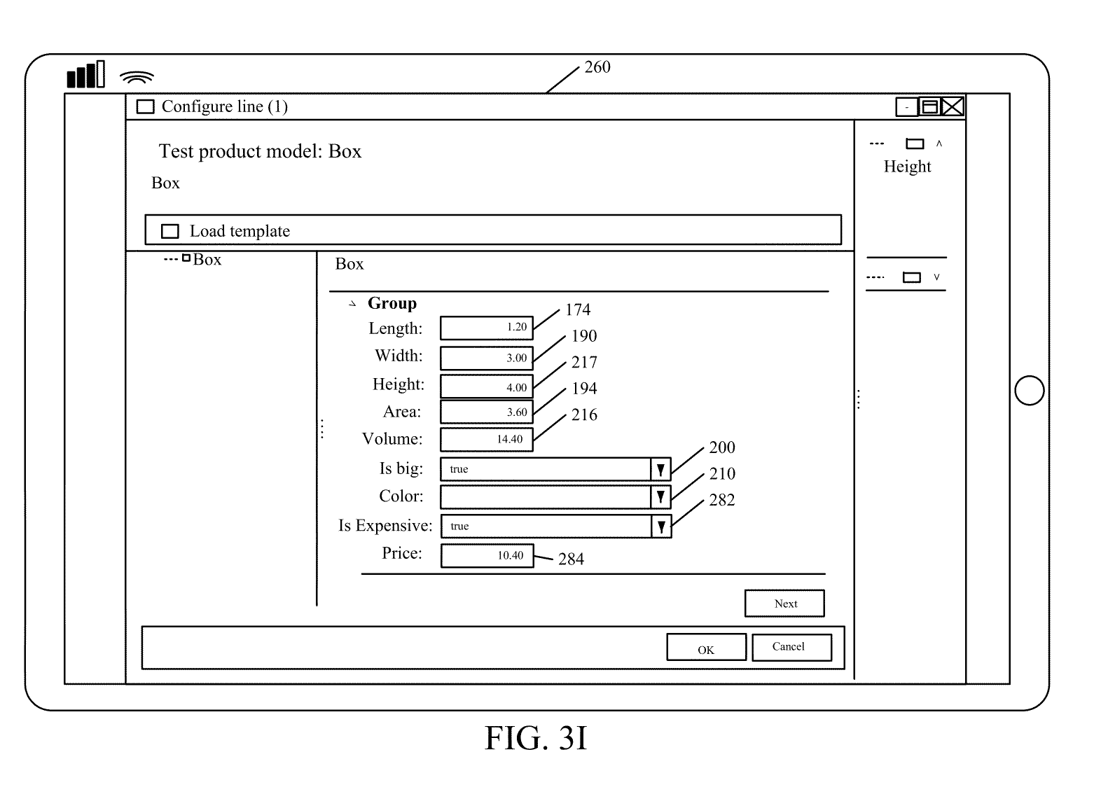

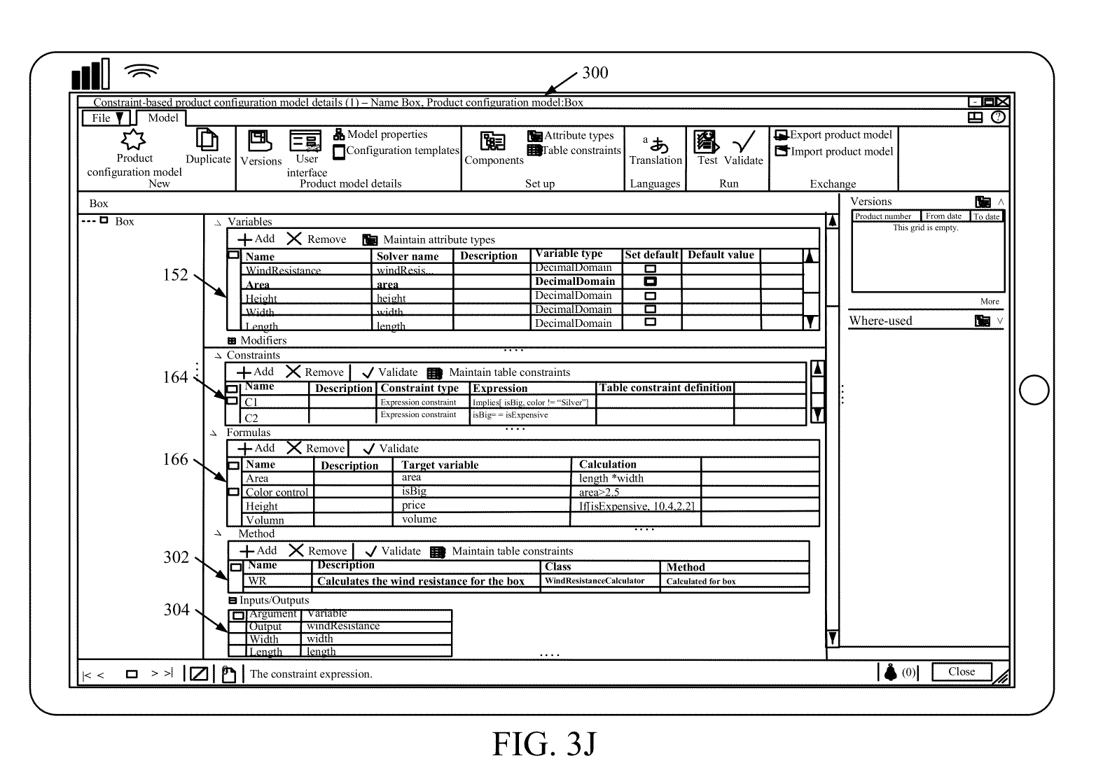

FIG. 2 is a flow diagram illustrating one embodiment of the overall operation of constraint-based configuration system 100, shown in FIG. 1, in more detail. FIGS. 3A-3J show illustrative user interface displays generated by system 100. FIGS. 2 and 3A-3J will now be described in conjunction with one another.

The present description will proceed with system 100 being a configuration system that allows a user to configure a box. This is an example only and it is described for illustrative purposes only. System 100 can be used in many different environments.

FIG. 3A is one example of a user interface display 148 that shows characteristics of a product configuration model that allows a user to configure the box. The model includes a set of variables 152 that can be set by the user. Each variable 152 has a name in column 154, a name that is used by CSP solver component 110 in column 156, and a variable type in column 158. While the example shows both a user friendly name in column 154 and a name used by component 110 in column 156, a single name could be used as well. Additional variables can be added using add button 160, and they can be removed using remove button 162. The variables shown at 152 include variables that can be defined using a decimal value, or floating point value. Those variables include area, height, width, length and volume. It will be noted that variables can be of other, more complex, types such as dates, strings, classes, etc.

The variables 152 also include a Boolean variable “isBig”. As is described below, if the area of the box exceeds a given threshold value, then the “isBig” Boolean variable has a value of true. If the area is less than the threshold, then the “isBig” Boolean variable has a value of false.

Variables 152 also include a variable that is defined in an enumerated text domain. That variable is the color. The model for the box also includes at least one constraint shown at 164 and a set of formulas shown at 166. The constraint Implies [isBig, color !=“sliver”] is named C1. The variable isBig is part of the C1 constraint. The C1 constraint means that if the “isBig” Boolean variable is set to true, then the color cannot be “silver”.

The formula at 166 named Area shows that the area is calculated by multiplying the length variable by the width variable. The Color control formula sets its target variable (the Boolean variable “isBig”) to true if the area calculation (area >2.5) is true. The volume formula is calculated to set its target variable (volume) to a value calculated by multiplying the area variable by the height variable.

In order to begin configuring the box, the user first provides a suitable input (such as a product identifier) that identifies a product that the user wishes to configure (e.g., the box). Configurator component 108 then generates a user interface display 102 (using user interface component 122) that has user input mechanisms 104 that can receive an input from user 106. This is indicated by block 150 in FIG. 2. It will be noted that display 102 can be generated separately from component 108 as well, such as by a third party.

Continuing with the description of the overall operation of system 100, FIG. 3B is one embodiment of a user interface display 170 that allows user 106 to input values for various variables for consideration by configurator component 108. User 106 can input a value for the length variable, the width variable, the height variable, the area variable, or the volume variable. These values can be decimal values, floating point values or other numerical values. Similarly, the user can select a color from a corresponding dropdown menu, and the user can also set the Boolean variable “isBig” to true or false from a dropdown menu. It will be noted that while the user can input values for all of these variables, the user can also input values for only some of the variables and the rest can be calculated by configurator component 108 (e.g., by either using CSP solver component 110 or evaluation engine 112, or both).

Next, referring again to FIG. 2, configurator component 108 receives a user input that sets a variable to a value. Receiving the user input setting a variable to a value is indicated by block 176 in FIG. 2 and receiving a value for a variable through evaluation or influence by another portion of the system (as described below) is indicated by block 177. FIG. 3C shows one embodiment of a user interface display 172 in which the user 106 has entered the decimal value 1.20 as the length variable by typing it in length text box 174. Because the user has only entered the decimal value 1.20 as the length variable, there is not enough information to evaluate any of the constraints or perform any of the calculations specified in constraint section 164 and formulas section 166 in FIG. 3A. Thus, nothing else happens. This can be seen from the flow diagram shown in FIG. 2. The variable has had a value set by the user (in this case) and this is indicated by block 177 in FIG. 2. Having received a variable value, configurator component 108 determines whether the configuration for the product (e.g., the box) is complete. That is, configurator component 108 determines whether all variable values have been set sufficiently to completely configure the product. This is indicated by block 179 in FIG. 2. The answer is no, because only the length value has been input.

Configurator component 108 thus notifies CSP solver component 110 that the user has provided an input. This is indicated by block 178 in FIG. 2. CSP solver component 110 then determines whether the variable (the value input for the length) is part of a constraint evaluated by the CSP solver. The answer to this question is no, because the only variables that are part of a constraint in the present embodiment shown at 164 in FIG. 3A are the Boolean “isBig” variable and the color variable. Therefore, processing continues at block 176. Determining whether the variable is a part of a constraint evaluated by the CSP solver component 110 is indicated by block 180 in FIG. 2.

Configurator component 108 also (at the same time as it notifies component 110) notifies evaluation engine 112 that a variable has had a value set. This is indicated by block 182 in FIG. 2. Evaluation engine 112 determines whether the value of the variable is an input to a formula or a method. This is indicated by block 184. It can be seen that the answer to this is yes, because one of the formulas set out at 166 in FIG. 3A is the area formula which takes, as its input, the length and the width. Therefore, evaluation engine 112 then determines whether the formula or method (in this case, the area formula) has all inputs set to a value so it can be calculated. This is indicated by block 186 in FIG. 2. The answer to this is no, because only the length variable has been set to a value. The area formula also needs the width variable to be set to a value. Therefore, as with processing at the CSP solver component 110, processing at the evaluation engine 112 reverts back to block 176 where configurator component 108 awaits another input.

FIG. 3D shows one embodiment of a user interface display 188 where the user has also input a value for the width variable in text box 190. Again, configurator component 108 determines that another variable has had a value set by the user in block 177. Configurator component 108 then again determines that the configuration is not complete at block 179. Configurator component 108 notifies CSP solver component 110 of the width value input at block 178. CSP solver component 110 then determines whether the variable is part of a constraint that is to be evaluated by the CSP solver component 110. The answer to this is no. The only constraint that is evaluated by CSP solver component 110 is the C1 constraint. Therefore, processing from the CSP solver component branch in FIG. 2 again returns to block 176 to wait for another user input or to block 177, which waits for an input from another portion of the system.

Configuration component 108 also notifies the evaluation engine 112 of the new variable value at block 182. Evaluation engine 112 determines whether the variable is an input to a formula or method. Again, the answer to this is yes because the area formula takes, as its input, the length and the width.

Evaluation engine 112 then determines whether the formula or method has all inputs set to a value. The answer to this is also yes, because the user has input a value for both the length variable and the width variable of the box (the product). Therefore, evaluation engine 112 calls the callable library component 114 or invokes the mathematical function evaluator component 116 to evaluate the formula or methods that have the desired inputs. This is indicated by block 192 in FIG. 2.

In the embodiment being discussed, the area formula is automatically evaluated by mathematical function evaluator component 116, which multiples the length value (1.20) by the width value (1.30) to arrive at a value for the area variable which is 1.56. The resulting area value is returned by evaluation engine 112 to configurator component 108 which displays it in the area text box 194. Setting the target variable (the area variable) to the resulting value (1.56) and displaying it is indicated by block 196 in FIG. 2.

It will also be noted that when evaluation engine 112 returns the result of the area calculation to configurator component 108, configurator component 108 determines that a new variable has had its value set through evaluation of the evaluation engine 112. That is, the area variable has now had its value set by the evaluation engine 112. Therefore, configurator component 108 again returns to processing at block 179 and determines whether configuration of the box is complete. The answer, of course, is no, because only the length, the width, and area have been either input or calculated.

Therefore, configurator component 108 simultaneously (or at a different time) notifies CSP solver component 110 that the value for the area variable has been set and also notifies evaluation engine 112 that the value for the area variable has been set. This is indicated by blocks 178 and 182 in FIG. 2. CSP solver component 110 determines whether the area variable is part of a constraint that is to be evaluated by CSP solver component 110. The answer to this is no, again because the only constraint to be evaluated is the C1 constraint.

However, the evaluation engine 112 determines that the value for the area variable is an input to another formula. That is, it is an input to both the color control formula that sets the “isBig” variable and the “volume” formula that calculates a value for the volume variable. Determining this is indicated by block 184 in FIG. 2. The color control formula only needs one input, and that is the value for the area variable. The volume formula needs both the area value and the height value. Since the height value has not been either input or calculated, the volume formula will not be evaluated by evaluation engine 112.

However, at block 186 it is determined that the color control formula has all of the inputs needed in order to evaluate it. Therefore, at block 192, evaluation engine 112 performs a comparison using evaluation engine 112, or calls a method on callable library component 114. Either the comparison, or the method call, returns a value of “true” for the “isBig” variable if the area value is greater than 2.5 and returns a “false” value for the “isBig” variable if the area is not greater than 2.5. Since the calculated area is only 1.56, the comparison or method call returns a value of “false” for the Boolean “isBig” variable. Evaluation engine 112 then sets the Boolean variable to “false” and returns it to configurator component 108 which displays it.

It can be seen that, in FIG. 3D, the “isBig” Boolean variable is set to “false” in text box 200. Based on this, configurator component 108 then again determines at block 177 that another variable has had a value set through evaluation. That is, the “isBig” Boolean variable has had its value set to “false” by evaluation of the color control formula. There are no more formulas to be evaluated based on setting the “isBig” variable to “false” so processing on the evaluation engine side of FIG. 2 is complete at the moment.

However, configurator component 108 notifies CSP solver component 110 that the Boolean variable “isBig” has had its value set. CSP solver component 110 determines at block 180 that the Boolean variable is part of a constraint that is to be evaluated by CSP solver component 110. It can be seen at 164 in FIG. 3A that if the “isBig” Boolean variable is set to true, then the box cannot be silver. However, if it is set to false, then there is no constraint on the color of the box, and all colors that are offered, are available for the box. Therefore, CSP solver component 110 fixes the variable to the false value in the CSP solver. This is indicated by block 204. CSP solver component 110 then finds solutions to the C1 constraint satisfaction problem and optionally displays them.

In the present example, the C1 constraint does not apply because all colors are available. However, finding the solution is indicated by block 206 in FIG. 2. CSP solver component 110 then determines whether any other variables have only one feasible value given those which have already been fixed. This is indicated by block 208 in FIG. 2. The answer to this is no, so processing reverts back to blocks 176 and 177.

FIG. 3E shows one embodiment of a user interface display 202 that illustrates the operation of CSP solver component 110. It can be seen in FIG. 3E that the “isBig” variable has been set to “false” in box 200. Therefore, when the user invokes the dropdown menu for colors by actuating button 210, dropdown menu 212 is displayed. It can be seen that all of the colors offered for the box are available and selectable by the user, including silver. The user can select a color.

FIG. 3F, however, shows a user interface display 214 indicating how the C1 constraint is applied when the user sets the value for the width variable to 3.0 instead of 1.3 in text box 190. Evaluation engine 112 automatically invokes mathematical function evaluator component 116 to calculate the area as 3.60. By automatically it is meant that this is done without any further user action required. A comparison by engine 112, or a method call by callable library component 114 evaluates the Boolean variable “isBig” to true, because it is greater than 2.5. Therefore, the Boolean variable is set to true in text box 200. Then, when the user actuates button 210 to display dropdown menu 212, it can be seen that all of the colors are available, except silver. This is because CSP solver component 110 has applied the C1 constraint that if the “isBig” Boolean variable is set to true, then the box cannot be silver.

FIG. 3G shows one embodiment of a user interface display 215 in which the user has also set the height variable in height text box 217 to 4.0. In that case, the same type of processing occurs and evaluation engine 112 invokes mathematical function evaluator component 116 to evaluate the “volume” formula and set that value to 14.40. This is displayed in text box 216. Configuration component 108 then determines that configuration is complete. Therefore, processing ends at block 179.

The above discussion has related to the model shown in FIG. 3A. However, other models could be used as well. FIG. 3H shows another embodiment of a user interface display 250. User interface display 250 illustrates the characteristics for a model of a box, which is similar to that shown in FIG. 3A, and similar items are similarly numbered. However, it can be seen that additional variables have been added to the box. A “price” variable has been added and this is in the decimal domain. In addition, an “isExpensive’ variable has been added and this is in the Boolean domain.

Similarly, another constraint 164 (C2) has been added which indicates that the “isBig” Boolean variable is to have the same value as the “isExpensive” Boolean variable. That is, if the “isBig” Boolean variable is set to true, then the “isExpensive” variable is also set to true, and vice versa. Similarly, if one is set to false, both are set to false.

FIG. 3H also shows that another formula 166 has been added. The price formula is set so that if the “isExpensive” Boolean variable is true, the price is set to 10.4. Otherwise, it is set to 2.2.

FIG. 3I shows another user interface display 260. User interface display 260 is similar to user interface display 215 shown in FIG. 3G, and similar items are similarly numbered. However, the additional variables and formulas and constraints are also shown. Therefore, it can be seen that the length has been set to 1.20, the width has been set to 3.00, and the height has been set to 4.00. The area has been evaluated to 3.60 and the volume has been evaluated to be 14.40. Based on the value for the area variable, the “isBig” Boolean variables has been evaluated to true, and thus, based on the additional C2 constraint shown in FIG. 3H, the “isExpensive” Boolean variable is also set to true.

Referring again to the flow diagram shown in FIG. 2, once the length and width variables are specified, then the area variable is calculated by mathematical function evaluator component 116. Mathematical function evaluator component 116 (or callable library 114) then also determines that the Boolean variable “isBig” is set to true. The CSP solver component 110 will be notified of this at block 178 and it will determine that the “isBig” variable is an input to the C1 constraint, and it adds this constraint to the CSP problem, thus eliminating the color silver from the options that can be chosen by the user. This is automatically performed at blocks 180, 204 and 206 in FIG. 2.

Also, because the “isBig” variable has been set to true, CSP solver component 110 determines at block 208 that other variables have only one feasible value. Because the C2 constraint has been added that the value of the “isBig” variable is identical to the value of the “isExpensive” variable, then because the “isBig” variable has been set to true, the “isExpensive” variable can be inferred to be true as well. Therefore, at block 280, CSP solver component 110 infers the value of the “isExpensive” Boolean variable as true and displays that value at block 282 in FIG. 3I. Configurator component 108 then determines that the “isExpensive” variable has been set to true by inference at block 177 and notifies the evaluation engine 112 of this change.

Evaluation engine 112 determines that this is an input to the price formula and therefore evaluates the price formula to set it to a value of 10.4, because the “isExpensive” Boolean variable has been set to true. This value is set, and displayed in text box 284 in FIG. 3I. This processing is automatically performed at blocks 184, 186, 192 and 196 in FIG. 2.

The user can then select a color. Configurator component 108 then determines that the configuration is complete at block 179, and the processing ends.

FIG. 3J is one embodiment of a user interface display 300 which shows a model for the box that is similar to that shown in FIG. 3H, and similar items are similarly numbered. In sum, it can be seen that the model has variables 152, constraints 164, and formulas 166. However, the model shown in user interface display 300 also includes method calls 302 that can be made to callable library component 114, along with the inputs and outputs for those method calls at 304. In addition, it can be seen that a wind resistance variable has been added and a wind resistance calculator class has been named in the callable library component 114. A method referred to as “calculate for box” has also been defined. The method “calculate for box” will be invoked when the length, width, and height of the box are known, in order to set the wind resistance attribute to a value in the decimal domain.

It can thus be seen that the configurator model divides the constraint processing and mathematical calculation and function call processing into two separate stages which both automatically inform the configurator component 108. The configurator component 108 also automatically notifies both the CSP solver component 110 and the evaluation engine 112 of the results of the other. Therefore, the system handles decimal and floating point values and automatically makes even complex calculations, on the fly, and automatically displays them. It also infers values, when they can be inferred. Because the decimal values and complex calculations are handled separately from the CSP solver component, there is very little affect on the performance of CSP solver component 110. It is substantially solving constraint problems, without the decimal values or calculations affecting it.

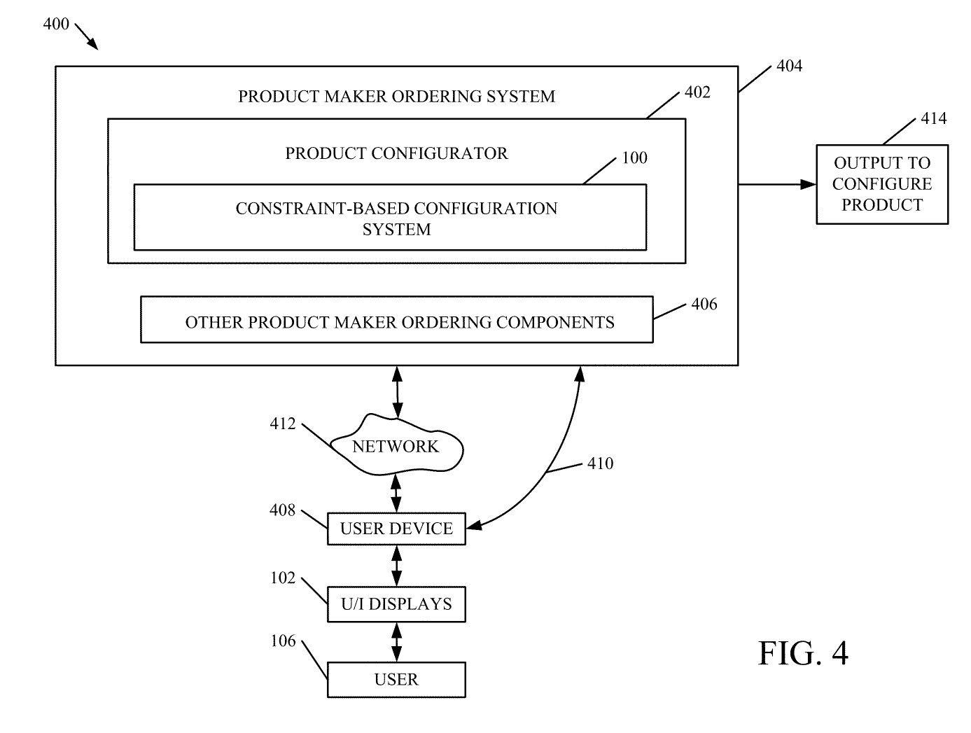

It will also be noted that the discussion above with respect to FIGS. 1-3J has been primarily in the context of a product configurator, the product being a box. However, that is only one application, and the constraint-based configuration system can be deployed in a wide variety of other contexts as well. FIG. 4 shows one architecture 400 where constraint-based configuration system 100 can be deployed. It can be seen in FIG. 4 that system 100 is deployed within a product configurator 402 for a product maker ordering system 404. That is, a product maker or manufacturer has an ordering system 404, within which a product configurator 402 deploys constraint-based configuration system 100. The system 404 can also have other ordering components 406 as well, although they are optional. The architecture 400 shown in FIG. 4 also shows that user 106 interacts with user interface displays 102 that are displayed on a user device 408. User device 408 can either interact with product maker ordering system 404 directly (as indicated by arrow 410) or through a network 412. In any case, the output of the product configurator 402 can be provided to another system, as output 414, in order to configure the product for user 106.

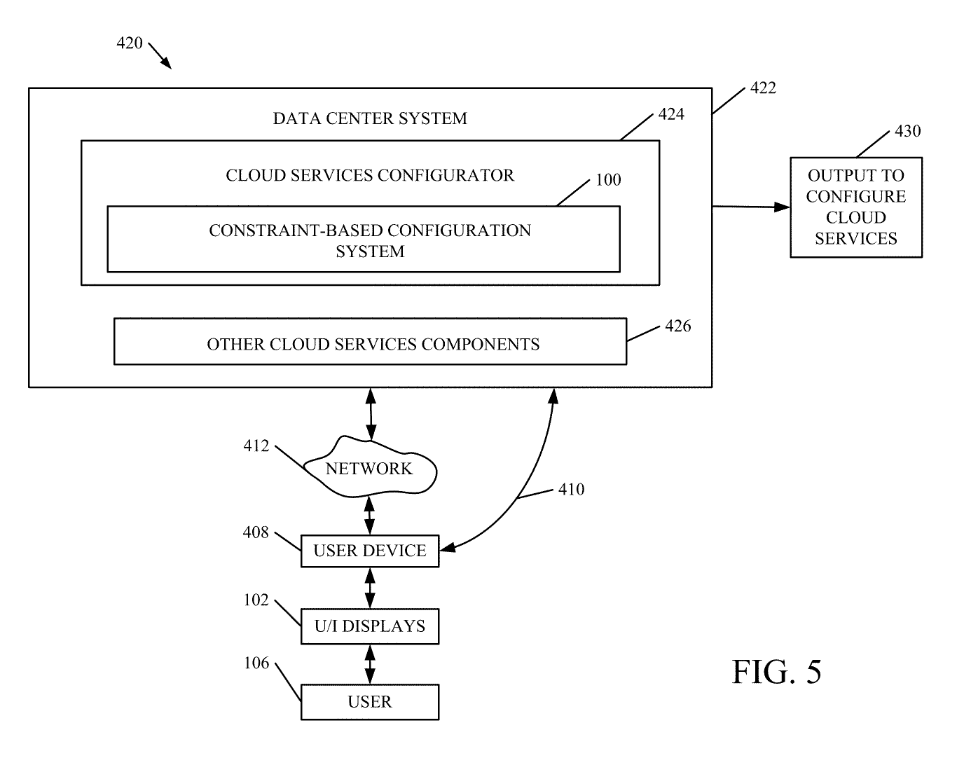

FIG. 5 shows another architecture 420 in which constraint-based configuration system 100 is deployed. Architecture 100 shows a data center system 422 that includes a cloud services configurator 424. System 422 can have other cloud services components 426 as well. In the architecture shown in FIG. 5, user 106 is configuring cloud-based services or other data center services, as user 106 desires. System 422 generates an output 430 which can be provided to other systems, to configure the cloud services desired by user 106.

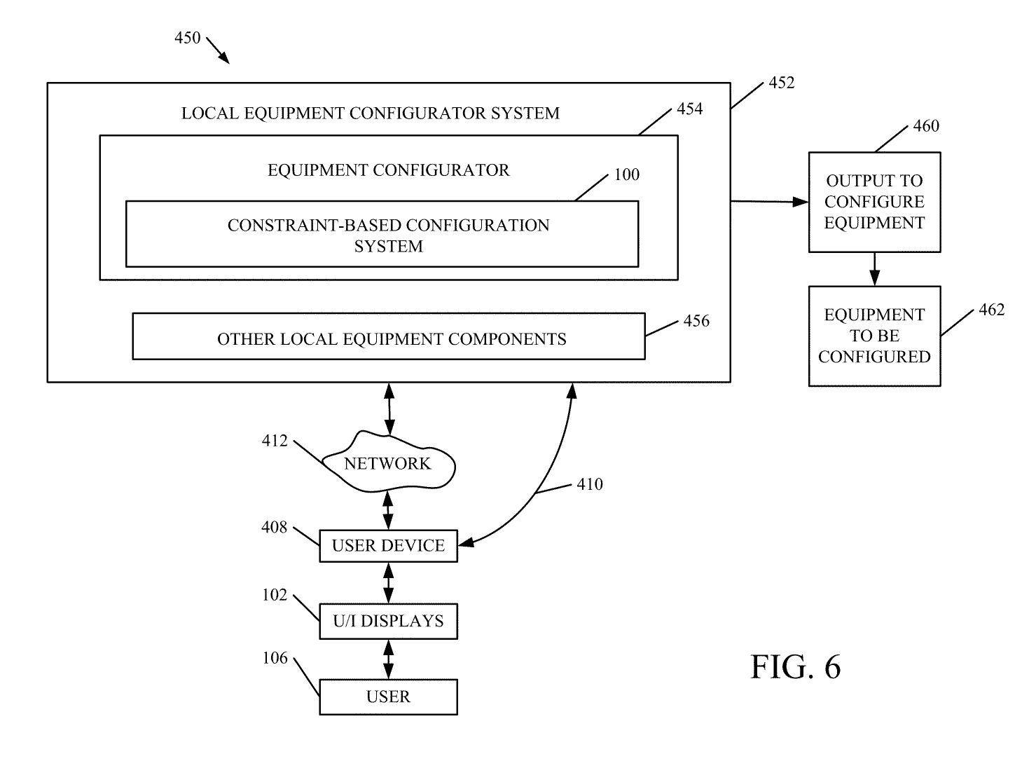

FIG. 6 shows yet another architecture 450 in which constraint-based configuration system 100 can be deployed. Architecture 450 shows a local equipment configurator system 452 that includes equipment configurator 454. System 452 can include other equipment components 456 as well. System 452 is used to configure a piece of local equipment for a desired application. By local it is meant that the equipment is already owned and is not being configured prior to purchase, as this was covered in a previous embodiment. For example, assume that user 106 works for an organization that owns a pump. Assume also that the pump is to be deployed in a given application. In that embodiment, constraint-based configuration system 100 may be used to configure certain characteristic of the pump so that it operates in a desired way. By way of example, assume that the pump has a configurable stroke length or displacement. This can be set by user 106 using constraint-based configuration system 100. Similarly, of course, the operation speed of the pump may be configurable or any of a wide variety of other aspects of the pump may be configurable as well. Where configuration constraints are to be applied, constraint-based configuration system 100 can be used to do so. System 452 illustratively generates an output 460 that can be used to configure the particular piece of equipment (e.g., the pump) 462.

Other embodiments can be used as well. For instance, system 100 can be used to configure a network, setup and configure an application, configure an operating system, etc.

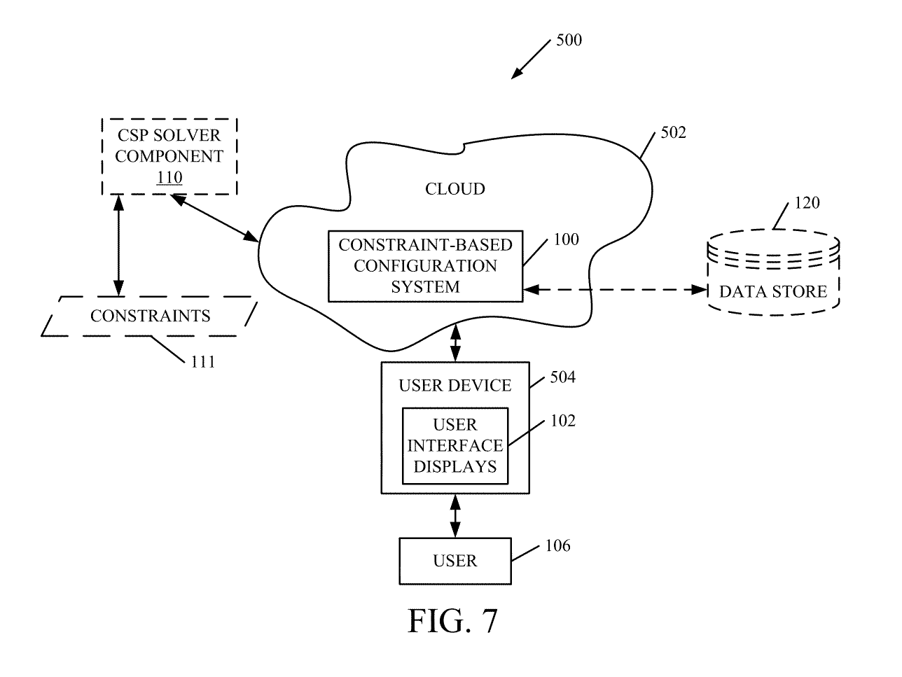

FIG. 7 is a block diagram of system 100, shown in FIG. 1, except that it is disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 7, some items are similar to those shown in FIG. 1 and they are similarly numbered. FIG. 7 specifically shows that system 100 is located in cloud 502 (which can be public, private, or a combination where portions are public while others are private). Therefore, user 106 uses a user device 504 to access those systems through cloud 502.

FIG. 7 also depicts another embodiment of a cloud architecture. FIG. 7 shows that it is also contemplated that some elements of system 100 are disposed in cloud 502 while others are not. By way of example, data store 120 can be disposed outside of cloud 502, and accessed through cloud 502. In another embodiment, CSP solver component 110 and constraints 111 are also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, feature phones, smart phones, multimedia players, personal digital assistants, etc.

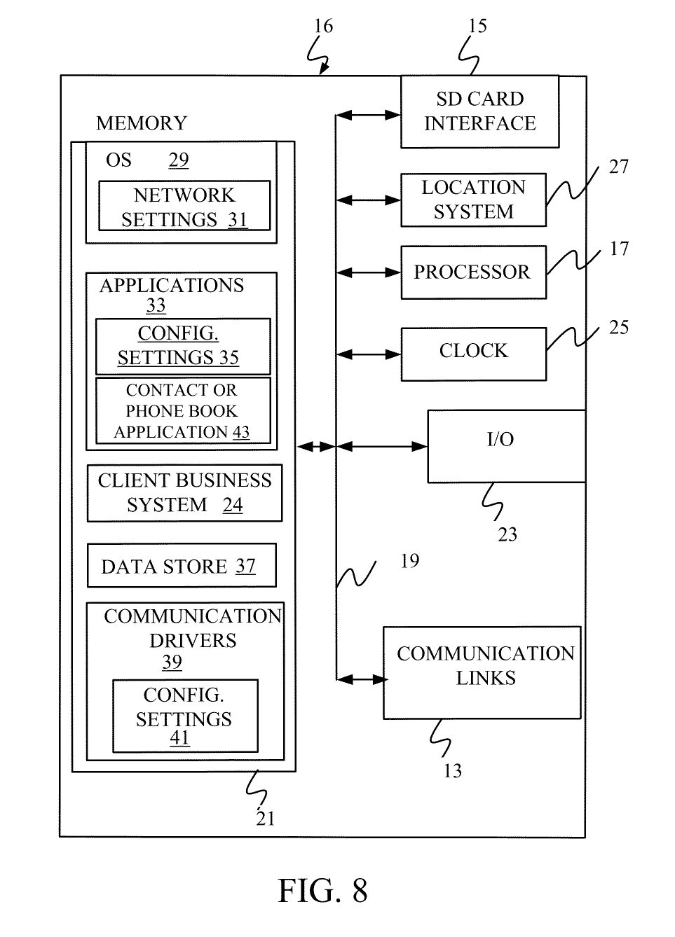

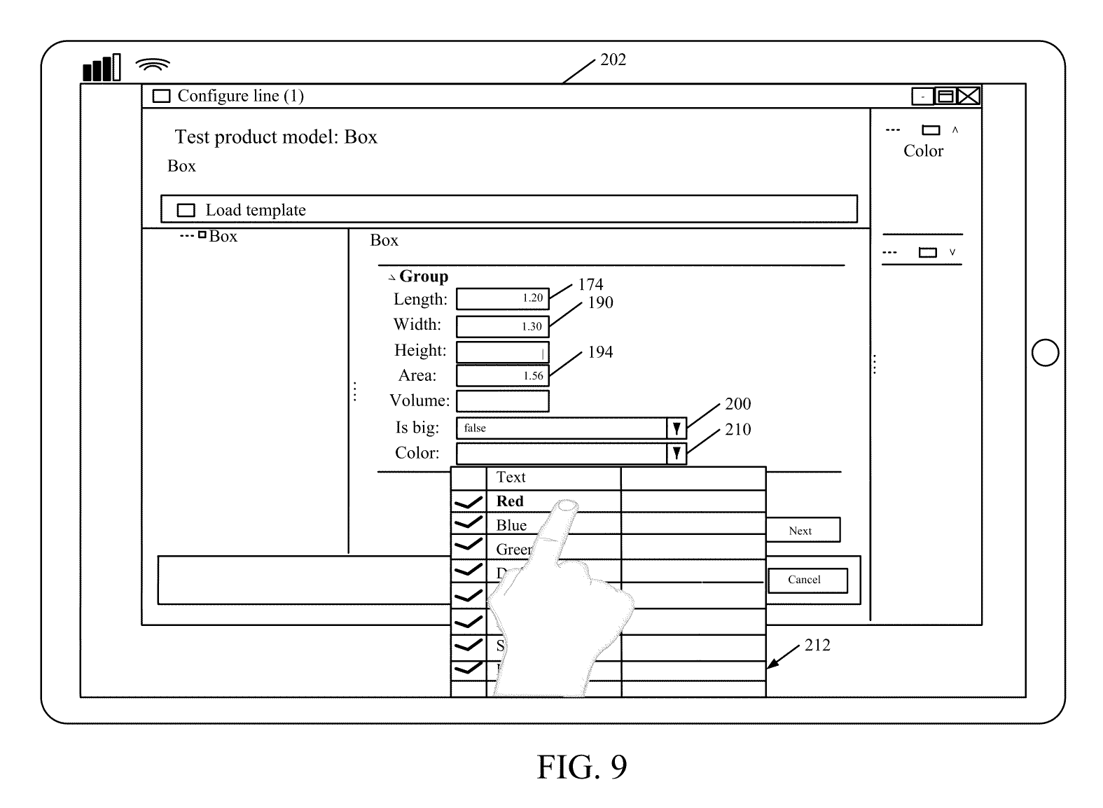

FIG. 8 is a simplified block diagram of one illustrative embodiment of a handheld or mobile computing device that can be used as a user's or client's hand held device 16, in which the present system (or parts of it) can be deployed. FIGS. 9-12 are examples of handheld or mobile devices.

FIG. 8 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 100) are received on a removable Secure Digital (SD) card that is connected to a SD card interface 15. SD card interface 15 and communication links 13 communicate with a processor 17 (which can also embody processor 118 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. System 100 or constraints 111, or the items in data store 120, for example, can reside in memory 21. Similarly, device 16 can have a client system 24 which can run various business applications or embody parts or all of system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 9 shows one embodiment in which device 16 is a tablet computer 600. In FIG. 9, computer 600 is shown with user interface display 202 (used to select a color) displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

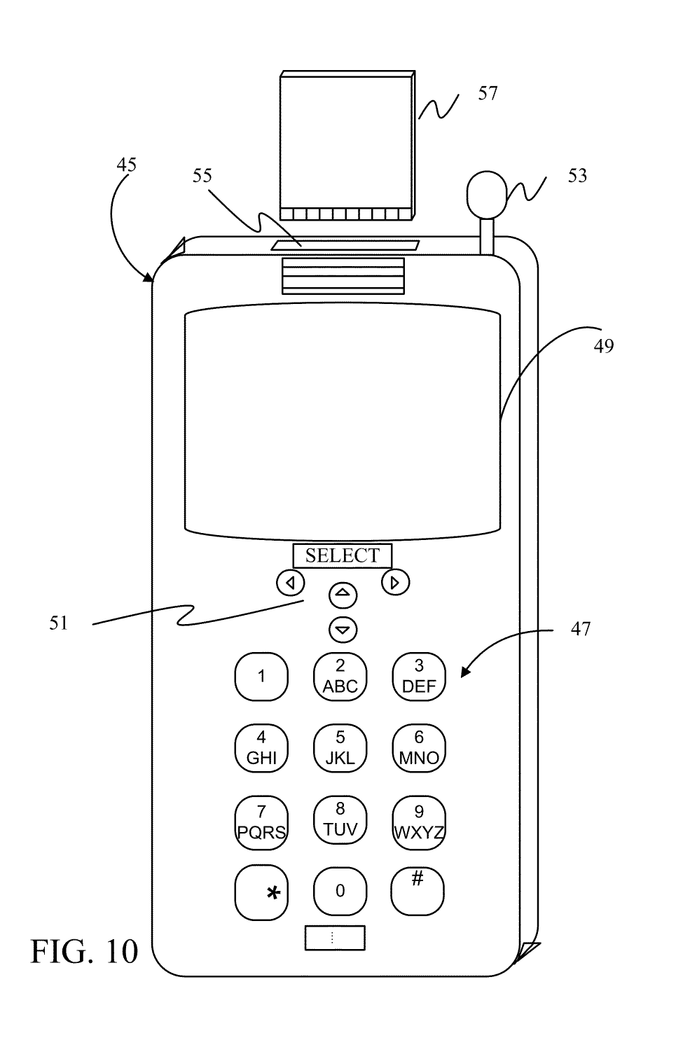

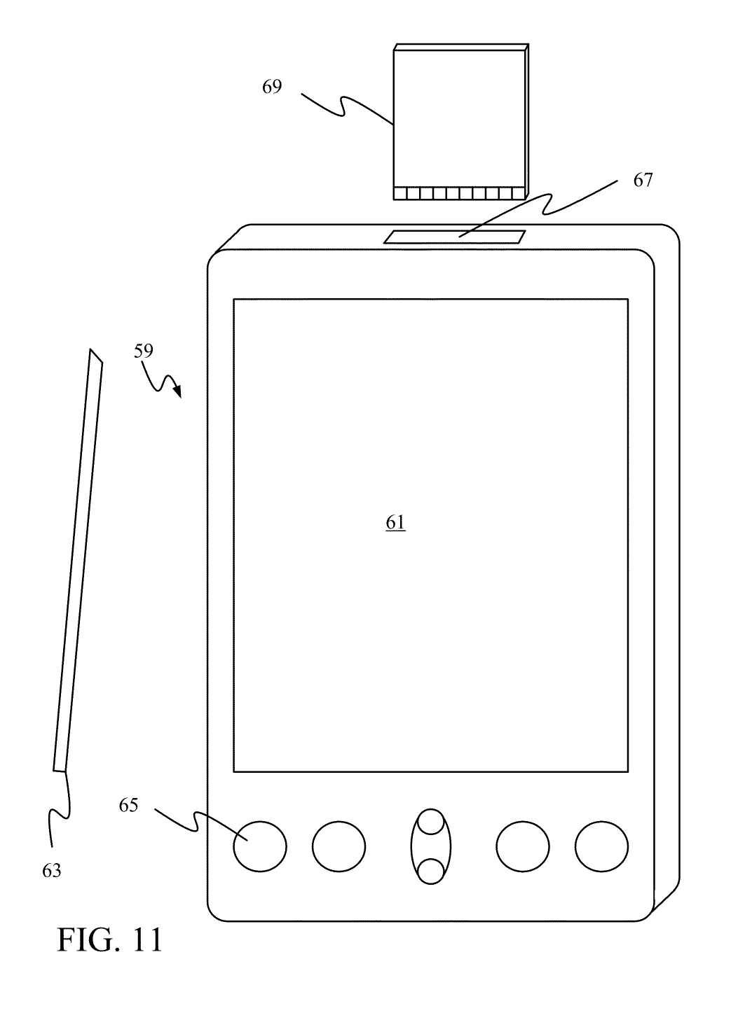

FIGS. 10 and 11 provide additional examples of devices 16 that can be used, although others can be used as well. In FIG. 10, a feature phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1×rtt, and Short Message Service (SMS) signals. In some embodiments, phone 45 also includes a Secure Digital (SD) card slot 55 that accepts a SD card 57.

The mobile device of FIG. 11 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

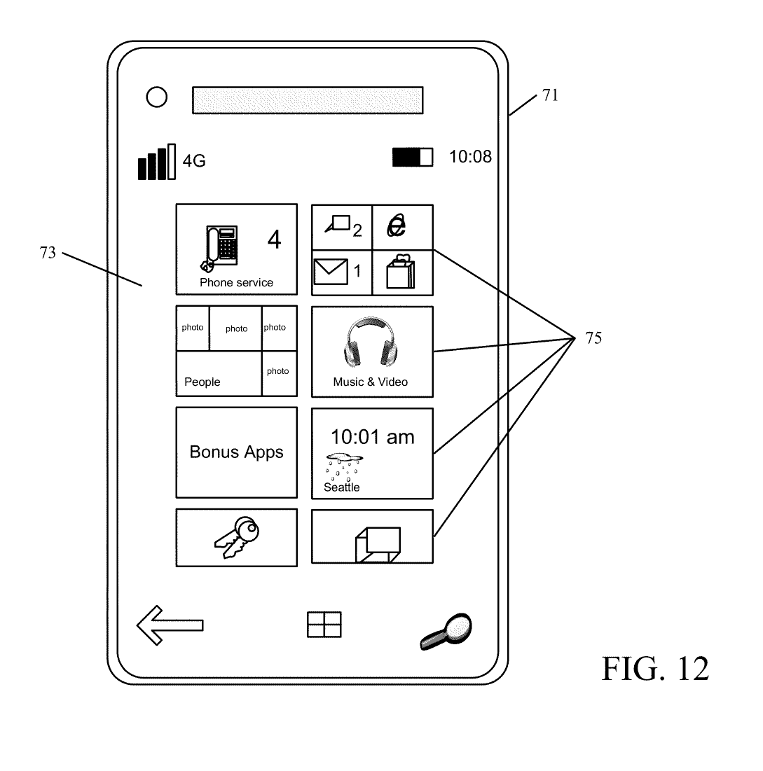

FIG. 12 is similar to FIG. 10 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

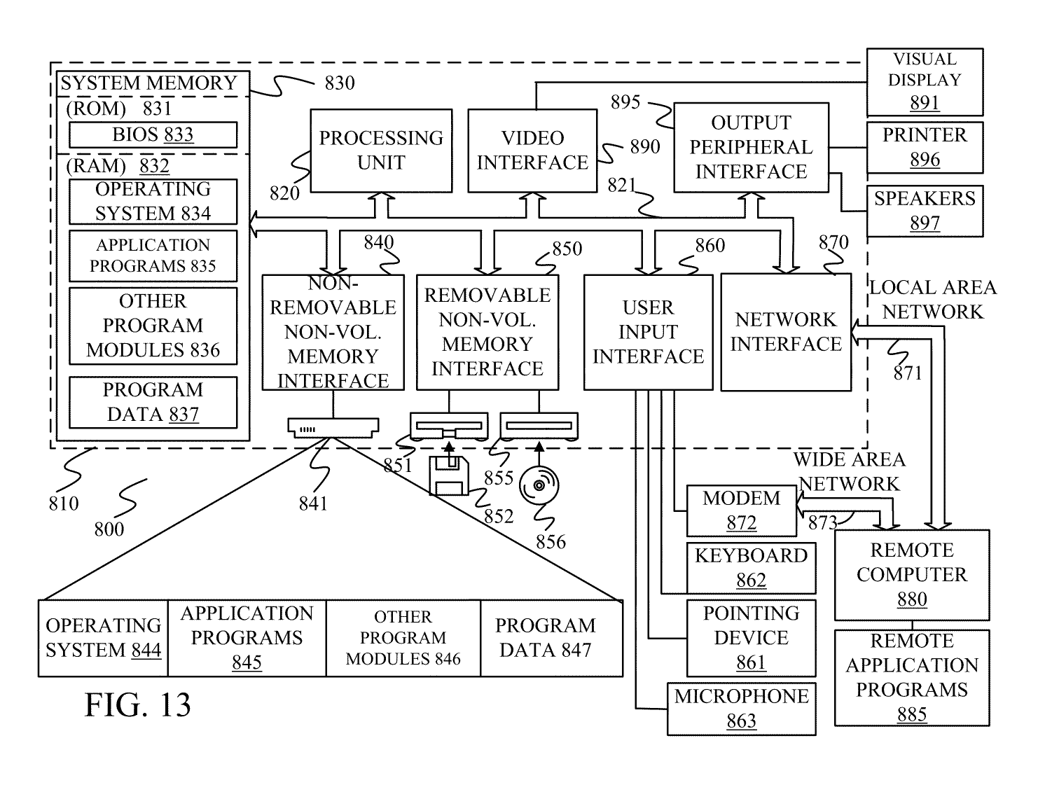

FIG. 13 is one embodiment of a computing environment in which system 100 (for example) can be deployed. With reference to FIG. 13, an exemplary system for implementing some embodiments includes a general-purpose computing device in the form of a computer 810. Components of computer 810 may include, but are not limited to, a processing unit 820 (which can comprise processor 118), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 13.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 13 illustrates operating system 834, application programs 835, other program modules 836, and program data 837.

The computer 810 may also include other removable/non-removable volatile/nonvolatile computer storage media. By way of example only, FIG. 13 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 13, provide storage of computer readable instructions, data structures, program modules and other data for the computer 810. In FIG. 13, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 13 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 13 illustrates remote application programs 885 as residing on remote computer 880. It will be appreciated that the network connections shown are exemplary and other means of establishing a communications link between the computers may be used.

It will also be noted that while various embodiments have been described, they can be combined as well. For instance, parts of one embodiment can be combined with parts of another embodiment. All of these are contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of performing a configuration, comprising:
receiving, at a user interface display of a constraint-based configuration system, a configuration input as a numerical user input value in numerical form, setting a value for a configuration variable;
automatically evaluating a mathematical formula, used for the configuration, with an evaluation engine, based on the numerical user input value; and
displaying a value for a second configuration variable based on a result of the evaluation of the mathematical formula on the user interface display.

2. The computer-implemented method of claim 1 and further comprising:
automatically providing the result of the evaluation of the mathematical formula to a constraint solver component.

3. The computer-implemented method of claim 2 and further comprising:
automatically evaluating constraints based on the result of the evaluation of the mathematical formula.

4. The computer-implemented method of claim 3 and further comprising:
displaying an indication that the constraints is evaluated.

5. The computer-implemented method of claim 4 and further comprising:
when a mathematical formula is evaluated to a formula result, providing the formula result to the constraint solver component; and
determining at the constraint solver whether at least one constraint can be evaluated based on the formula result.

6. The computer-implemented method of claim 6 and further comprising:
if at least one constraint can be evaluated based on the formula result, evaluating the at least one constraint and displaying an indication of the evaluated at least one constraint.

7. The computer-implemented method of claim 6 and further comprising:
determining at the constraint solver, whether a value for an additional configuration variable can be inferred based on the results.

8. The computer-implemented method of claim 4 and further comprising:
when a constraint is evaluated to a constraint result, providing the constraint result to the evaluation engine; and
determining at the evaluation engine whether at least one formula can be evaluated based on the constraint result.

9. The computer-implemented method of claim 8 and further comprising:
if at least one formula can be evaluated based on the constraint result, evaluating the at least one formula and displaying an indication of the evaluated at least one formula.

10. The computer-implemented method of claim 1 wherein automatically evaluating a mathematical formula, used for the configuration, with an evaluation engine, based on the numerical user input value, comprises:
calling a method on a callable library, from the evaluation engine, inputting the numerical user input value; and
receiving the result of the evaluation from the method.

11. The computer-implemented method of claim 1 wherein automatically evaluating a mathematical formula, used for the configuration, with an evaluation engine, based on the numerical user input value, comprises:
invoking a mathematical function calculator, inputting the numerical user input value; and
receiving the result of the evaluation from the mathematical function calculator.

12. The computer-implemented method of claim 1 wherein receiving a configuration input as a numerical user input value in numerical form comprises receiving a decimal value or a floating point value.

13. The computer-implemented method of claim 1 wherein receiving a configuration input comprises receiving the configuration input at a product configuration system.

14. The computer-implemented method of claim 1 wherein receiving a configuration input comprises receiving the configuration input at a cloud services configuration system.

15. A constraint-based configuration system, comprising:
a configurator component that generates a user interface display with a user input mechanism to receive a numerical user input;
an evaluation engine that receives the numerical user input from the configurator component and automatically evaluates a mathematical formula to a numerical result based on the numerical user input and returns the numerical result to the configurator component, the configurator component automatically displaying output values based on the numerical result; and
a computer processor that is a functional part of the system and activated by the configurator component, and the evaluation engine, and facilitates evaluating the mathematical function.

16. The constraint-based configuration system of claim 15 wherein the configuration component receives a constraint user input and further comprising:
a constraint solver component that receives the constraint user input from the configurator component and evaluates a constraint to a constraint result based on the constraint user input and returns the constraint result to the configurator component.

17. The constraint-based configuration system of claim 15 wherein the configurator component receives a decimal value or a floating point value as the numerical user input.

18. The constraint-based configuration system of claim 15 and further comprising:
a callable library having methods callable by the evaluation engine to evaluate the a method; and
a mathematical function evaluator component, that can receive the numerical user input from the evaluation engine, to evaluate the mathematical formula.

19. A computer readable storage medium that stores computer readable instructions which, when executed by a computer, cause the computer to perform a method, comprising:
receiving, at a user interface display of a constraint-based configuration system, a product identifier indicative of a product to be configured;
receiving, at the user interface display, a configuration input as a numerical user input value in decimal form, the numerical user input being indicative of a value for a configuration variable;
automatically evaluating a mathematical formula, used for the configuration, with an evaluation engine, based on the numerical user input value; and
displaying a second configuration variable of the product to be configured based on a result of the evaluation of the mathematical formula on the user interface display.

20. The computer readable storage medium of claim 19 and further comprising:
automatically providing the result of the evaluation of the mathematical formula to a constraint solver component;
automatically evaluating a constraint based on the result of the evaluation of the mathematical formula; and
displaying an indication that the constraint is evaluated.
